(19) United States
(12) Patent Application Publication
(10) Pub. No.: US 2024/0170906 A1
(43) Pub. Date: May 23, 2024

(54) HIGH-OUTPUT LASER BEAM TRANSMISSION DEVICE USING INDEX MATCHING FLUID

(71) Applicant: HILLAB INC., Pohang-si, Gyeongsangbuk-do (KR)

(72) Inventor: Seung Jin HWANG, Pohang-si, Gyeongsangbuk-do (KR)

(21) Appl. No.: 18/283,978

(22) PCT Filed: Dec. 10, 2021
(86) PCT No.: PCT/KR2021/018711

§ 371 Date: Sep. 25, 2023

(30) Foreign Application Priority Data
Aug. 26, 2021 (KR) 10-2021-0112845

(51) Int. Cl. H01S 3/00

(52) U.S. Cl. CPC H01S 3/0071; H01S 3/0064

(57) ABSTRACT

Provided is a high-power laser beam transmission device using an index matching fluid. The high-power laser beam transmission device may include an optical fiber transmitting a laser beam, and an index matching fluid disposed at both ends of the optical fiber emitting a laser beam received from the optical fiber. According to the present disclosure, an index matching fluid having a refractive index similar to that of an optical fiber is disposed at both ends of the optical fiber, thereby minimizing a reflection loss.

### TECHNICAL FIELD

The present disclosure relates to a high-power laser beam transmission device using an index matching fluid, and particularly, to a high-power laser beam transmission device using an index matching fluid in which a reflection loss of a high-power laser beam is minimized by disposing an index matching fluid, which has a refractive index similar to an optical fiber, at the end of the optical fiber.

### BACKGROUND ART

High-power laser beam transmission devices that generate a high-energy laser beam are used in various fields, so they are under active study. In particular, when a high-energy laser beam is transmitted to an optical fiber, there is a problem that the optical fiber is easily damaged due to high instantaneous power. An optical fiber is damaged usually by high instantaneous power on an incidence surface and an emission surface, which is a main factor that decreases transmission efficiency together with Fresnel reflection.

For example, when energy of 1 J is transmitted to an optical fiber, power of 1 W for 1 second is enough for a continuous wave (CW) laser, but when the energy is transmitted for 1 second through 10 laser pulses having a pulse width of 10 ns, 0.1 J per pulse, power of 10 MW passes instantaneously 10 times through the optical fiber, so the optical fiber may be damaged.

The damage limit of silica-based optical fibers has been generally known as power density of 1 GW/cm². Since the diameter of common large-diameter optical fibers is 1 mm, about 10 MW becomes 1 GW/cm² or more in average on an optical fiber surface in accordance with unit conversion, so transmission is impossible and about 0.08 J per pulse may be a limit. In addition, this calculation is established even under the assumption that a laser beam is uniform and constructive interference of laser beams does not occur, so, in fact, a laser having much lower energy per pulse should be used or the diameter of the optical fibers should be larger.

Accordingly, there is a need for a method of preventing damage to an optical fiber by attenuating constructive interference when transmitting a laser beam to an optical fiber in a high-power laser beam transmission device.

FIG. 1 is a conceptual diagram of a high-power laser beam transmission device including a beam homogenizer of the related art. Referring to FIG. 1, when an existing beam homogenizer that transmits a uniform laser beam to an optical fiber is used, constructive interference due to the beam homogenizer is generated, so there is a problem that damage is probabilistically generated even within the range of a damage limit. That is, a fine pattern is generated due to constructive interference.

FIG. 2 is an exemplary view of a cut cross-section of an optical fiber.

Referring to FIG. 2, the cut cross-section of the optical fiber is not uniform, so when a laser beam is received or emitted with the cross-section in contact with the air in this state, the shape and direction of the laser beam may be distorted and a large reflection loss may be generated. In general, distortion of a laser beam is prevented and a reflection loss is minimized by making a uniform surface through polishing and coating, but there is a problem that the cost for polishing and coating optical fibers is high, management is required to prevent dirt or other dirt from sticking, and it is difficult to immediately cope with damage when damage is generated.

When mediums are changed while light is transmitted, the reflectivity may be changed in accordance with the difference in refractive index between the mediums. When a laser is transmitted to an optical fiber in the air, a large amount of energy loses on an incidence surface and an emission surface due to the difference in refractive index between mediums. For example, assuming that the refractive index of air is 1.00, the refractive index of a silica optical fiber is 1.46, and there is only a vertical incidence angle, the following reflectivity formula is applied.

$$R = {\vert \frac{{n}_{1} - {n}_{2}}{{n}_{1} + {n}_{2}} \vert}^{2} = {\vert \frac{1.46 - 1.}{1.46 + 1.} \vert}^{2} \approx 3.6 \%$$

That is, the tranmissivity is 96.4% because the reflectivity is 3.6%, and when these terms are applied to an incidence surface and an emission surface, the transmission efficiency of a single optical fiber is 92.9%.

A method of polishing and coating two surfaces of an optical fiber is generally used to solve this matter, but this method has a problem that the cost is high, there is a high possibility of damage to the coating surface in the process of transmitting a high-power laser, and there is no method that can immediately cope with damage at an industrial site when damage is generated. In particular, in the case of an emission surface, the characteristics of a laser beam may be changed, depending on the polished state.

As a related art, a technique of installing a lens in an integrated type on a holder for fixing an optical fiber that transmits external light or twisting ends of optical fibers and curing a hardening portion in a liquid state into a solid state has just been disclosed in Korean Patent No. 10-2162642 (Optical transmission optical fiber with lens and method for manufacturing the same).

### DISCLOSURE

### Technical Problem

An objective of the present disclosure is to provide a high-power laser beam transmission device using an index matching fluid in which a reflection loss is minimized by disposing an index matching fluid at the end of an optical fiber.

### Technical Solution

A high-power laser beam transmission device using an index matching fluid according to an embodiment of the present disclosure includes an optical fiber transmitting a laser beam, and an index matching fluid disposed at both ends of the optical fiber discharging a laser beam received from the optical fiber. The index matching fluid is a liquid having a same refractive index as the optical fiber.

The high-power laser beam transmission device further includes an anti-reflective coating window disposed on a side of the index matching fluid in an emission direction of a laser beam. The high-power laser beam transmission device further includes a lens disposed on a side of the index matching fluid in an emission direction of a laser beam. The high-power laser beam transmission device further includes a camera configured to align a focus position of the received laser beam and the optical fiber.

### Advantageous Effects

According to the present disclosure, an index matching fluid having a refractive index similar to or same as that of an optical fiber is disposed at both ends of the optical fiber, thereby minimizing a reflection loss.

Since the end of an optical fiber is in contact with an index matching fluid instead of air, it is not required to polish or separately coat both ends of the optical fiber, so there is an effect of reducing a cost, there is no need for management for preventing dirt from sticking to both ends of the optical fiber, and it is possible to immediately replace the optical fiber at the site when the optical fiber is damaged.

### DESCRIPTION OF DRAWINGS

FIG. 1 is a conceptual diagram of a high-power laser beam transmission device including a beam homogenizer of the related art.

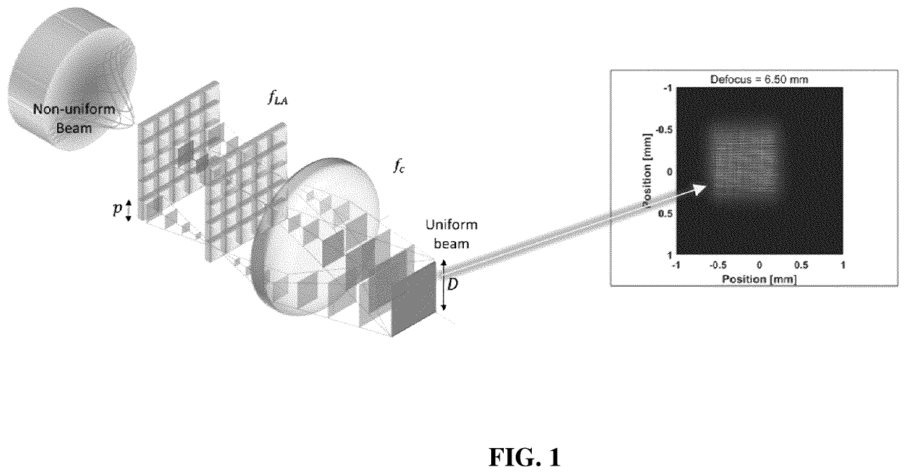

FIG. 2 is an exemplary view of a cut cross-section of an optical fiber.

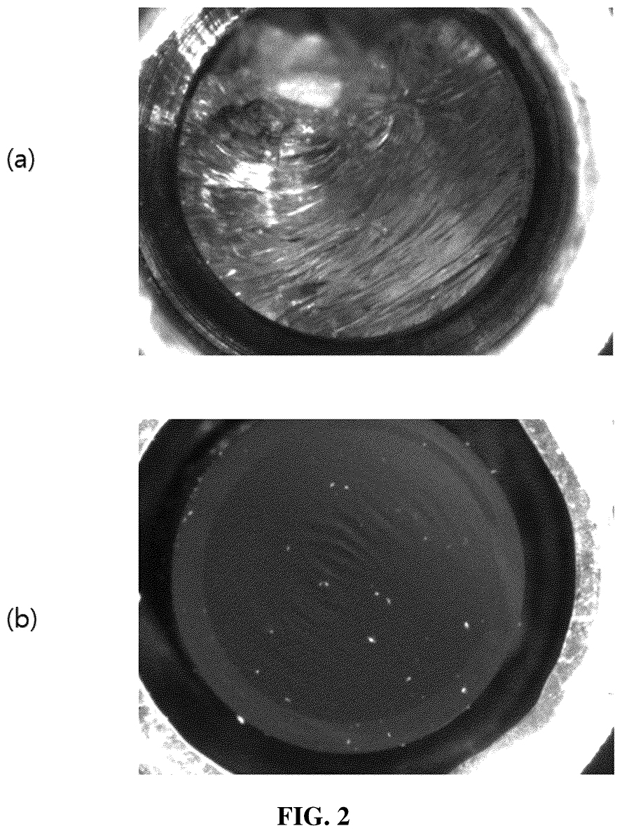

FIG. 3 is a configuration diagram of a high-power laser beam transmission device using an index matching fluid according to an embodiment of the present disclosure.

FIG. 4 is a configuration diagram of a high-power laser beam transmission device using an index matching fluid and an anti-reflective coating window according to another embodiment of the present disclosure.

FIG. 5 is a configuration diagram of a high-power laser beam transmission device using an index matching fluid and a lens according to another embodiment of the present disclosure.

### MODE FOR INVENTION

Specific structural and functional description about embodiments according to the concept of the present disclosure disclosed herein is exemplified only to describe the embodiments according to the concept of the present disclosure and the embodiments according to the concept of the present disclosure may be implemented in various ways and are not limited to the embodiments described herein.

Embodiments described herein may be changed in various ways and various shapes, so specific embodiments are shown in the drawings and will be described in detail in this specification. However, it should be understood that the exemplary embodiments according to the concept of the present disclosure are not limited to the specific examples, but all of modifications, equivalents, and substitutions are included in the scope and spirit of the present disclosure.

Terms used in the specification are used only in order to describe specific exemplary embodiments rather than limiting the present disclosure. Singular forms are intended to include plural forms unless the context clearly indicates otherwise. It will be further understood that the terms “comprises” or “have” used in this specification, specify the presence of stated features, numbers, steps, operations, components, parts, or a combination thereof, but do not preclude the presence or addition of one or more other features, numerals, steps, operations, components, parts, or a combination thereof.

Hereafter, embodiments of the present disclosure are described in detail with reference to the accompanying drawings in the specification.

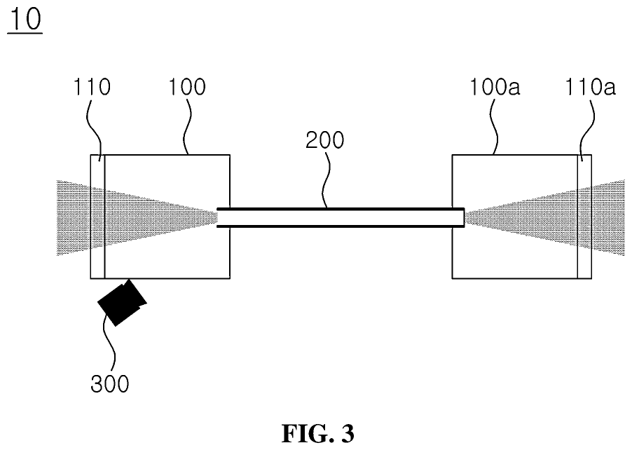

FIG. 3 is a configuration diagram of a high-power laser beam transmission device using an index matching fluid according to an embodiment of the present disclosure.

Referring to FIG. 3, a high-power laser beam transmission device is composed of an index matching fluid 100, an anti-reflective coating window 110, an optical fiber 200, and a camera 400.

Index matching fluids 100 and 100a are disposed respectively at both ends of the optical fiber 200 such that both ends of the optical fiber in contact with the index matching fluids without being exposed to the air. Laser beams 300 that are emitted from the optical fiber 200 can be transmitted through the index matching fluids and the anti-reflective coating windows. That is, the index matching fluids 100 and 100a may be disposed to cover the entire of an incidence surface and an emission surface of the optical fiber.

The index matching fluid 100 may be a liquid having a refractive index the same as or similar to that of the optical fiber and the index matching fluid 100 may be water, but is not limited thereto. The refractive index of the index matching fluid 100 may be in the range of 1.3 to 1.8. The index matching fluid 100 is in contact with a non-polished or non-coated optical fiber surface instead of air, thereby being able to minimize a reflection loss (Fresnel loss).

The anti-reflective coating windows 110 and 110a may be disposed on a side of the index matching fluid 100 and may be disposed in the emission direction of a laser beam from the index matching fluid 100. The anti-reflective coating window 110 may be the same in height as and different in horizontal width from the index matching fluid 100, but the present disclosure is not limited thereto. The anti-reflective coating window 110 enables a laser beam to be received or emitted through the index matching fluid 100, thereby being able to minimize a reflection loss.

When the optical fibers are changed, the camera 400 can acquire an image of the incidence surface of an optical fiber and can monitor and adjust the direction of a laser beam on the basis of the taken image. That is, the camera 400 can acquire an image of an incidence surface to align the focus position of a laser beam and an optical fiber.

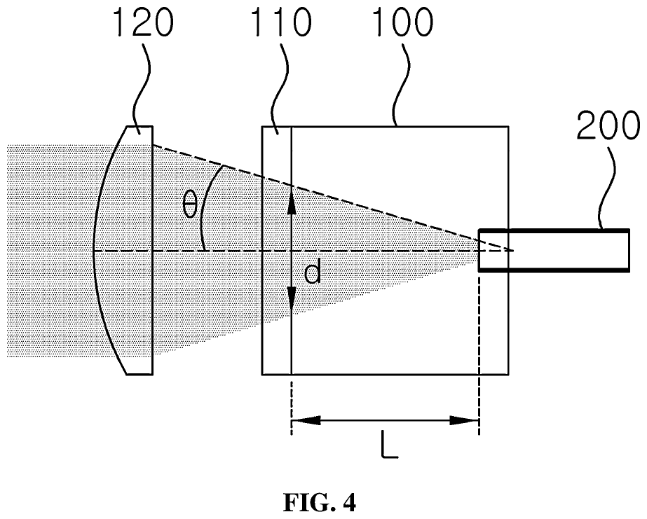

FIG. 4 is a configuration diagram of a high-power laser beam transmission device using an index matching fluid and an anti-reflective coating window according to another embodiment of the present disclosure.

Referring to FIG. 4, in a high-power laser beam transmission device 100, an anti-reflective coating window 110 is disposed on a side of an index matching fluid 100 in the emission direction of a laser beam. The index matching fluid 100 and the anti-reflective coating window 110 are disposed in contact with each other. The index matching fluid and the anti-reflective coating window are different in horizontal width but the same in height.

It is possible to calculate the diameter of a laser beam through the way in which the index matching fluid 100 and the anti-reflective coating window 110 are in direct contact. That is, when the diameter of a laser beam is variable or the amount of the index matching fluid needs to be minimized, it is possible to dispose and use the anti-reflective coating window 110. The anti-reflective coating window 110 should be disposed to be spaced apart over a predetermined distance from the optical fiber 200 in consideration of the damage limit of the anti-reflective coating window 110. Since the anti-reflective coating window 110 is closer to the optical fiber 120 than the lens, the possibility of damage to the anti-reflective coating window 110 is high, so only the anti-reflective coating window 110 is considered and the diameter of laser beam can be calculated by the following equation.

$$d = 2 L tan θ , \qquad \frac{4 E}{π {d}^{2}} \leq LIDT , \qquad L \geq \sqrt{\frac{E}{π ( LIDT ) tan θ}} , \qquad V \geq \frac{π {d}^{2}}{4} L ,$$

where NA (numerical aperture) is the number of apertures, n is the refractive index of an index matching fluid, θ is an incidence angle or an emission angle at an optical fiber, D is the diameter (reference of a clear aperture) of a lens/beam, f is the focal length of a lens, V is the necessary volume of an index matching fluid, E is the energy of a laser beam that is transmitted to an optical fiber, and LIDT is a laser induced damage threshold of the window.

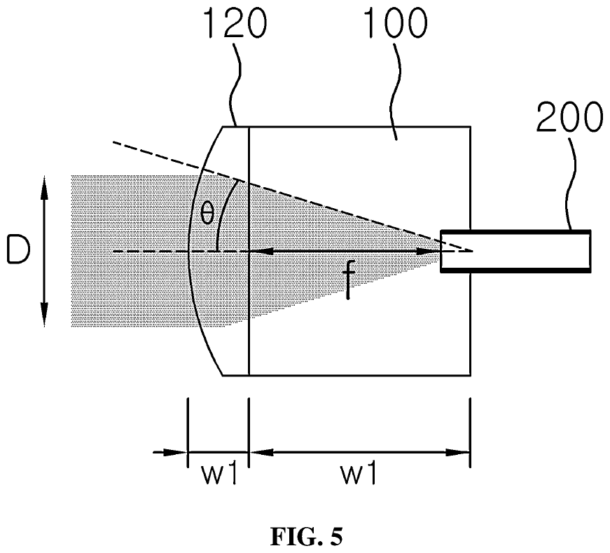

FIG. 5 is a configuration diagram of a high-power laser beam transmission device using an index matching fluid and a lens according to another embodiment of the present disclosure.

Referring to FIG. 5, a high-power laser beam transmission device 100 further includes a lens 120 is disposed on a side of an index matching fluid 100 in the emission direction of a laser beam. The index matching fluid 100 and the lens 120 are disposed in direct contact with each other. In this case, only the lens 120 is disposed without the anti-reflective coating window 110 of FIG. 4 and the lens 120 is formed convexly on a side in the emission direction of a laser beam. The index matching fluid 100 and the lens 120 are different in horizontal width but the same in height.

It is possible to calculate the diameter of a laser beam through the contact way of the index matching fluid and the lens. As a specification of an optical fiber, there is a numerical aperture (NA), and the angle of light that is received or emitted at the end of the optical fiber is determined in accordance with NA. It is possible to calculate the amount of an index matching fluid, the size of a container, and the focal distance of a lens on the basis of the diameter of a laser beam that is received and emitted at an optical fiber. The diameter of a laser beam can be calculated by the following equation.

$$NA = n sin θ , \qquad θ = {sin}^{- 1} \frac{NA}{n} , \frac{D / 2}{f} = tan θ , \qquad f = \frac{D}{2 tan ( {sin}^{- 1} \frac{NA}{n} )} , \qquad \frac{4 E}{π {D}^{2}} \leq LIDT , \qquad V \geq \frac{π {D}^{2}}{4} f ,$$

where NA (numerical aperture) is the number of apertures, n is the refractive index of an index matching fluid, θ is an incidence angle or an emission angle at an optical fiber, D is the diameter (reference of a clear aperture) of a lens/beam, f is the focal length of a lens, V is the necessary volume of an index matching fluid, E is the energy of a laser beam that is transmitted to an optical fiber, and LIDT is the laser induced damage threshold of a lens.

Although the present disclosure was described with reference to the exemplary embodiments illustrated in the drawings, those are only examples and may be changed and modified into other equivalent exemplary embodiments from the present disclosure by those skilled in the art. Therefore, the technical protective range of the present disclosure should be determined by the scope described in claims.

1. A high-power laser beam transmission device using an index matching fluid, comprising:
an optical fiber transmitting a laser beam; and
an index matching fluid disposed at both ends of the optical fiber and emitting a laser beam received from the optical fiber.

2. The high-power laser beam transmission device of claim 1, wherein the index matching fluid is a liquid having a same refractive index as the optical fiber.

3. The high-power laser beam transmission device of claim 1, further comprising an anti-reflective coating window disposed on a side of the index matching fluid in an emission direction of a laser beam.

4. The high-power laser beam transmission device of claim 1, further comprising a lens disposed on a side of the index matching fluid in an emission direction of a laser beam.

5. The high-power laser beam transmission device of claim 1, further comprising a camera configured to align a focus position of the received laser beam and the optical fiber.
